(19) United States
(12) Patent Application Publication
(10) Pub. No.: US 2013/0233955 A1
(43) Pub. Date: Sep. 12, 2013

(54) SHREDDER HAMMERS

(71) Applicant: ESCO CORPORATION, Portland, OR (US)

(72) Inventors: Daniel R. Morrow, Portland, OR (US); Michael R. Weeks, Portland, OR (US); David M. Graf, Scappoose, OR (US); Christopher M. Carpenter, Tualatin, OR (US)

(73) Assignee: ESCO Corporation, Portland, OR (US)

(21) Appl. No.: 13/789,031

(22) Filed: Mar. 7, 2013

Related U.S. Application Data
(60) Provisional application No. 61/608,485, filed on Mar. 8, 2012.

(51) Int. Cl. B02C 13/28

(52) U.S. Cl. CPC B02C 13/28
USPC 241/189.1; 241/197

(57) ABSTRACT

Shredder hammers having first and second major surfaces on opposing sides, and a circumferential edge. The hammer includes a mounting portion and a working portion. The mounting portion defines a mounting aperture that extends from the first major surface to the second major surface, and is configured to receive a hammer mounting pin. The working portion includes at least one recess in at least one of the first and second major surfaces with opposed walls that extend away from a distal portion of the circumferential edge. The hammers are used in shredding systems for shredding material.

### FIELD OF THE INVENTION

The present invention relates to industrial shredding systems. More particularly, this invention relates to shredding systems that include shredder hammers.

### BACKGROUND OF THE INVENTION

Industrial shredding equipment typically is used to break large objects into smaller pieces that can be more readily processed, for example as in the recycling industry. Commercially available shredders range in size from those that shred materials like rubber (e.g., car tires), wood, and paper to larger shredding systems that are capable of shredding scrap metal, automobiles, automobile body parts, and the like.

The core of most industrial shredding systems is the shredding chamber, where multiple shredder hammers are spun on a rotary shredding head, and repeatedly impact the material to be shredded against an anvil or other hardened surface. Shredder hammers are therefore routinely exposed to extremely harsh conditions of use, and so typically are constructed from hardened steel materials, such as low alloy steel or high manganese alloy content steel (such as Hadfield Manganese Steel). Shredder hammers may each weigh several hundred pounds (e.g., 150 to 1200 lbs.), and during typical shredder operations these heavy hammers slam into the material to be shredded at relatively high rates of speed. Even when employing hardened materials, the typical lifespan of a shredder hammer may only be a few days to a few weeks. In particular, as the shredder hammer blade or impact area undergoes repeated collisions with the material to be processed, the material of the shredder hammer itself tends to wear away.

It should be appreciated that the greater throughput that the shredding equipment can process, the more efficiently and profitably the equipment can operate. Accordingly, there is room in the art for improvements in the structure and construction of shredder hammers and the machinery and systems utilizing such hammers.

Examples of shredder hammers and industrial shredding equipment are disclosed in U.S. Pat. Nos. 1,675,464, 1,940,116, 1,954,175, 1,760,097, 2,534,301, 2,678,794, 2,716,526, 2,768,794, 2,750,124, 3,236,463, 3,738,586, 3,844,494, 4,141,512, 4,142,687, 4,310,125, 4,558,826, 4,805,842, 5,002,233, 5,073,038, 5,381,975, and 7,416,144; U.S. Patent Publication Nos. US20090250539, and US20100213301; and Japanese patent publication JP2007283243A. The disclosures of these and all other publications referenced herein are incorporated by reference in their entirety for all purposes.

### SUMMARY OF THE INVENTION

The invention includes shredder hammers having first and second major surfaces on opposing sides, and a circumferential edge. The hammer includes a proximal portion and a distal portion. The proximal portion defines a mounting aperture extending from the first major surface to the second major surface of the hammer to receive a hammer mounting pin. The distal portion of the hammer includes at least one recess in at least one of the first and second major surfaces to provide additional surfaces by which to further shred the material.

In the various preferred embodiments shown in the drawings, the recesses are formed in the working portion or region of the hammer and spaced from the primary impact face for efficient, reliable operation. Some of the illustrated recesses intersect with the circumferential edge of the hammer body. The invention further includes shredding systems incorporating shredder hammers having such recessed features.

In an additional aspect of the invention, the invention includes shredding systems, where the shredding system includes a rotary shredding head, a shredding chamber enclosing the rotary shredding head, and a plurality of shredder hammers pivotally coupled to the rotary shredding head. Each shredder hammer includes first and second major surfaces on opposing sides, a circumferential edge, and a proximal portion and a distal portion. The proximal portion of each hammer defines a mounting aperture to receive a hammer mounting pin, and the distal portion of at least one hammer includes at least one recess in at least one of the first and second major surfaces.

In a preferred embodiment, the invention includes a shredder hammer including a pair of major surfaces and a circumferential surface connecting the major surfaces. A hole extends through the hammer and opens in each of the major surfaces to receive a support pin for mounting the shredder hammer in the shredding machine. A working or distal portion of the hammer is remote from the hole and includes at least one recess that opens to a major surface. The recess includes opposing walls that extend from the wear edge of the working end.

The working portion of the hammer includes the wear edge and the section of the hammer proximate to the wear edge with the primary contact faces for impacting target materials to be separated. The working portion is subject to wear during operation and is a sacrificial part of the hammer.

Other aspects, advantages, and features of the invention will be described in more detail below and will be recognizable from the following detailed description of example structures in accordance with this disclosure.

### BRIEF DESCRIPTION OF THE DRAWINGS

FIG. 1 is a schematic depiction of a shredding system according to an exemplary embodiment of the present invention.

FIG. 2 is a front elevation view of a rotary shredding head according to an exemplary embodiment of the present invention.

FIG. 3 is a perspective view of the rotary shredding head of FIG. 2.

FIG. 4 is a front perspective view of a shredder hammer according to an exemplary embodiment of the present invention.

FIG. 4A is a front elevation view of a shredder hammer according to an exemplary embodiment of the present invention.

FIG. 5 is a rear perspective view of the shredder hammer of FIG. 4.

FIG. 6 is a front elevation view of the shredder hammer of FIG. 4.

FIG. 7 is a view of a cross-section of the shredder hammer of FIG. 6 along line 7-7, as indicated in FIG. 6.

FIG. 8 is a view of a partial cross-section of the shredder hammer of FIG. 6 along line 8-8, as indicated in FIG. 6.

FIG. 9 is a view of a partial cross-section of the shredder hammer of FIG. 6 along line 9-9, as indicated in FIG. 6.

FIG. 10 is a front perspective view of a shredder hammer according to an alternative exemplary embodiment of the present invention.

FIG. 11 is a rear perspective view of the shredder hammer of FIG. 10.

FIG. 12 is a front elevation view of a shredder hammer according to another alternative exemplary embodiment of the present invention.

FIG. 13 is a view of a cross-section of the shredder hammer of FIG. 12 along line 13-13, as indicated in FIG. 12.

FIG. 14 is a view of a partial cross-section of the shredder hammer of FIG. 12 along line 14-14, as indicated in FIG. 12.

FIG. 15 is a view of a partial cross-section of the shredder hammer of FIG. 12 along line 15-15, as indicated in FIG. 12.

FIG. 16 is a rear elevation view of the shredder hammer of FIG. 12.

FIG. 17 is a front perspective view of a shredder hammer according to another alternative exemplary embodiment of the present invention.

FIG. 18 is a rear perspective view of the shredder hammer of FIG. 17.

FIG. 19 is a front elevation view of a shredder hammer with inserts according to another alternative exemplary embodiment of the present invention.

FIG. 20 is a view of a cross-section of the shredder hammer of FIG. 19 along line 20-20, as indicated in FIG. 19.

FIG. 21 is an end view of the shredder hammer of FIG. 19 showing inserts.

FIG. 22 is a front elevation view of another embodiment of a shredder hammer in accordance with the invention.

FIG. 23 is an end view of the hammer shown in FIG. 22.

FIG. 24 is flowchart setting forth a method of manufacturing according to an exemplary embodiment of the present invention.

### DETAILED DESCRIPTION OF THE INVENTION

Forming one or more recesses on one or both of the major surfaces of a shredder hammer advantageously creates one or more auxiliary impact faces, thereby enhancing the operational efficiency of the shredder hammer. Improved shredding of the materials enhances post-processing providing efficient sorting of the ferrous and non-ferrous metals and other materials. During operation, the material is sheared, torn and crushed by the primary impact face of the shredder hammer and between the hammer and the anvil and by the recess surfaces. In the present invention, additional recesses provide edges on the working portion of the hammer that further grip and engage the target material, to improve throughput and separation.

Even though the forming of recesses in the major surfaces of the hammer remove material from the hammer, work hardening due to additional material impacts, especially at edges of recesses, extend the work hardening more deeply into the hammer body. As a result a larger percentage of the volume of the hammer body has improved operational material characteristics.

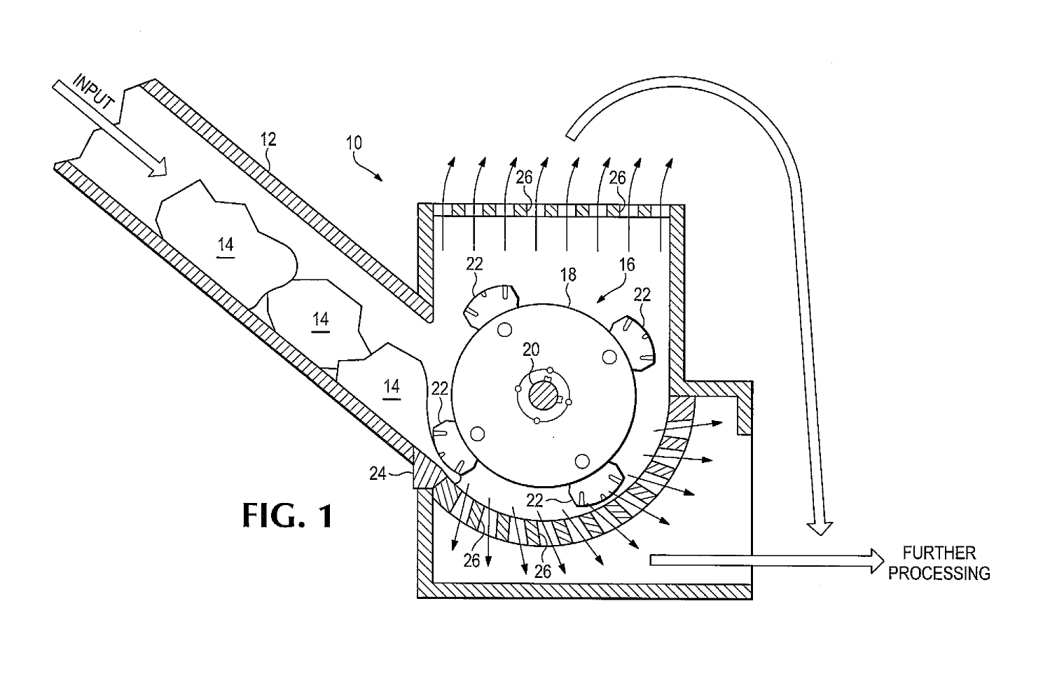

FIG. 1 schematically illustrates an exemplary industrial shredding system 10. The typical components of such a shredding system include a material intake (such as chute 12) that introduces material 14 to be shredded to a shredding chamber 16. The material 14 to be shredded may be of any desired size or shape. The material 14 is optionally pretreated, such as by heating, cooling, crushing, baling, etc. before being introduced into the shredding chamber 16. The material intake 12 may optionally include feed rollers or other machinery to facilitate feeding material 14 to chamber 16, and/or to control the rate at which material 14 enters chamber 16, and/or to prevent the material 14 from moving backward up the chute 12.

Within shredding chamber 16 is a rotary shredding head 18. Although the disclosure depicts a rotor or rotary shredding head, it should be appreciated that there are a variety of rotor configurations, including disc rotors, spider rotors, barrel rotors, and the like, that may also be used in the present shredding systems. Rotary shredding head 18 is equipped with a plurality of shredder hammers 22 according to the present invention, and is configured to rotate about a shaft or axis 20. Each shredder hammer 22 is independently pivotally mounted to the rotary shredding head, so that as shredding head 18 rotates, centrifugal forces acting on the shredder hammers 22 urges each hammer to extend outwardly, tending toward a position where the center of gravity of each hammer is as far as possible from rotation axis 20.

In this way, as rotary shredding head 18 rotates, the shredder hammers impact the material 14 to be shredded, and crush material 14 between hammer 22 and an anvil 24 (or other suitably hardened surface), breaking the material apart. As the shredder hammer 22 is rotatably mounted on the mounting pin 32, contact with the material 14 to be shredded may cause the shredder hammer 22 to slow down or even rotate in the opposite direction as it crushes the material 14 to be shredded against the anvil 24.

The resulting shredded materials may be discharged from the shredding chamber 16 through any one of the outlets 26 leading from the shredding chamber. As shown in FIG. 1, suitable outlets 26 may be provided in the bottom, top, or one or more sides of the chamber 16 walls. The shredded material may then be transported for collection and/or further processing.

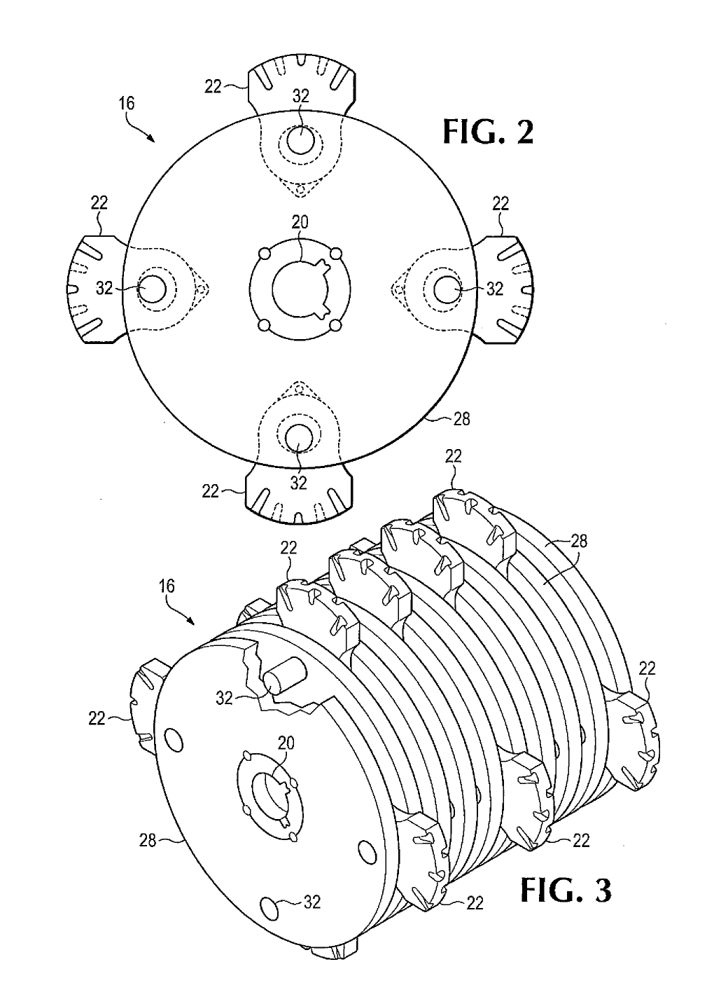

The wide variety of applications for these machines, from clay processing to automobile shredding, results in a wide range and variety of shredder configurations. FIG. 2 shows one typical example of a shredding head 16. Rotary shredding head 16 includes a plurality of rotor disks 28 that are separated from one another by spacers that are configured to be mounted around the drive shaft 20. While any number of rotor disks 28 may be utilized in a rotary shredding head, the illustrated example of shredding head 16 includes ten disks 28. Disks 28 may be fixedly mounted with respect to the shaft 20, for example by welding, mechanical coupling, etc., to allow the disks 28 to be rotated when shaft 20 is rotated by an external motor or other power source (not shown). In addition to providing a spacing function, spacers can also help protect the shaft 20 from damage, due to contact with material 14 as it is being shredded, or fragments of broken shredder hammers 22, and the like.

The rotary shredding head 16 further includes a plurality of hammer mounting pins 32 that extend between at least some of the rotor disks 28 and/or through the entire length of the shredding head 16. The shredder hammers 22 are rotatably mounted on the hammer mounting pins 32 so that they are capable of freely and independently rotating around the mounting pins. In this illustrated example, the shredding head 18 includes four mounting pins 32 around the circumference of the rotor disks 28, and shredder hammers 22 are shown mounted on selected pins 32 between each adjacent pair of rotor disks 28. It is recognized that three, four or more hammers can be mounted between adjacent disks depending on the specific application. The particular distribution of hammers may be modified as required by the end user, depending on end-user needs, although the hammers are typically positioned so that the shredding head is balanced with respect to rotation.

The mounting pins 32, shredder hammers 22, and rotor disks 28 may be structured and arranged so that, in the event that a shredder hammer 22 is unable to completely pass through the material 14, it can rotate to a location between adjacent disks 28 and thereby pass by the material 14 until it is able to extend outward again under the effect of the rotation of the shredder head 18. Alternatively, or in addition, the shredder hammer 22 may shift sideways on its mounting pin 32 as it passes by or through the material 14 to be shredded. If desired, the various parts of the shredder head 18 may be shaped and oriented with respect to one another such that a shredder hammer 22 can rotate 360° around its mounting pin 32 without contacting another mounting pin 32, the drive shaft 20, another hammer 22, etc.

Shredder hammers used in the art of industrial shredder construction and operation typically are constructed from especially durable materials, such as hardened steel alloys. Exemplary materials suitable for the fabrication of shredder hammers include low alloy steel or high manganese alloy content steel, among others. Particularly preferred are so-called work hardening steel alloys, a family of steel formulations that become harder the more it is subjected to impacts and/or compressive forces.

One such manganese alloy is Hadfield Manganese steel, which contains about 11% to about 14% manganese, by weight. Although Hadfield Manganese steel typically exhibits a Brinell hardness of approximately 220 Bhn, after continued impact and/or compression it may surface harden to a Brinell hardness of over 550 Bhn. Significantly, only the outer skin surface of the shredder hammer will typically harden, if the hammer is made from Hadfield Manganese steel, even under heavy use. The under layer typically remains ductile and tough. However, as the surface of the shredder hammer wears, the layer of material exhibiting increased hardness is renewed, gradually increasing in depth as the hammer surface is worn away.

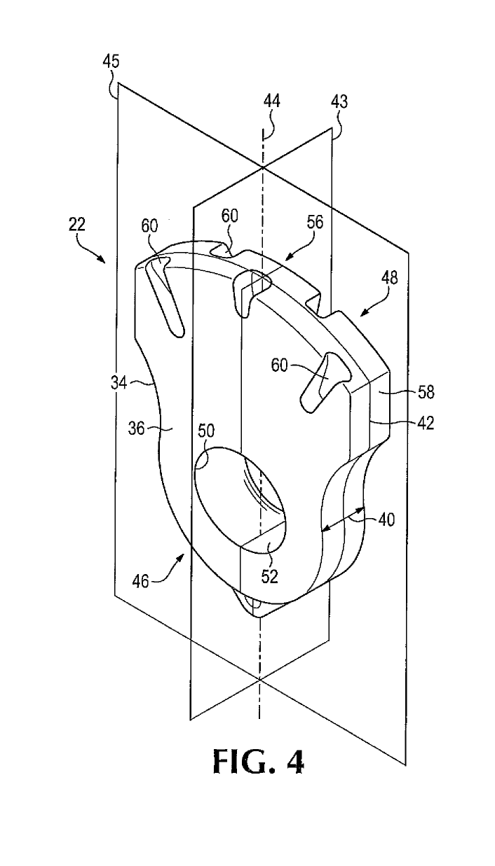

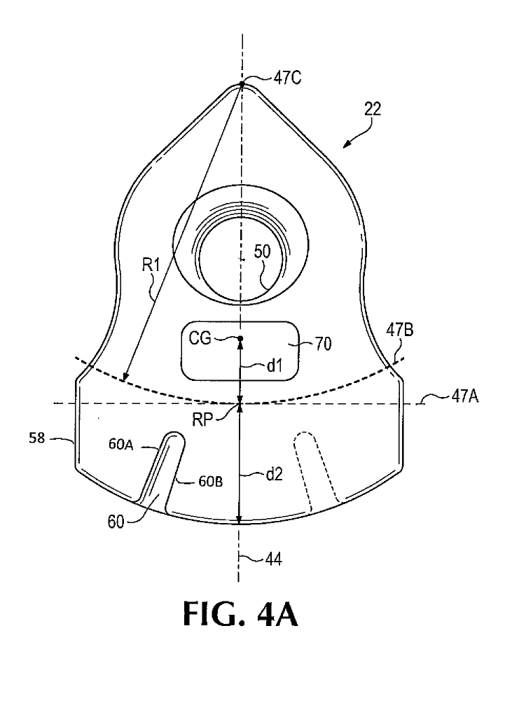

An exemplary shredding hammer 22 is depicted in FIGS. 4-9. Shredder hammer 22 includes a plate-like hammer body 34 that has a first major surface 36 and a second major surface 38 that define opposite sides of the hammer body 34. Major surface 36 and major surface 38 are separated by the thickness 40 of the hammer body 34. The thickness 40 of the hammer body 34 may be substantially constant, or it may vary over the area of the hammer body.

The shape of the hammer is largely defined by a circumferential edge 42 which extends between the first and second major surfaces 36, 38. The circumferential edge 42 is typically substantially perpendicular to at least one of the planes defined by the first major surface 36 or second major surface 38, or is substantially perpendicular to both the first major surface 36 and second major surface 38. The circumferential edge typically includes a plurality of edge segments, including one or more curved edge segments, so as to define the overall outline of the hammer. In one embodiment of the present invention, the outline of the hammer is mirror-symmetric with respect to a plane of symmetry 43, where the plane of symmetry 43 includes a longitudinal axis 44 of the hammer, and is perpendicular to at least one of the first and second major surfaces. Hammer 22 defines a midplane 45 that pass through longitudinal axis 44 and between first and second major surfaces 36 and 38. In another embodiment of the present invention, the circumferential edge 42 delineates an outline that is approximately bell-shaped. In another embodiment of the present invention, the distal portion of the circumferential edge 42 is made up of a series of linear faces that intersect one another at obtuse angles.

The hammer 22 includes and defines a mounting aperture or opening 50 that is configured to receive the hammer mounting pin 32 in order to rotatably mount the shredder hammer to the rotary shredding head 18. The mounting aperture typically extends from the first major surface 36 to the second major surface 38 of the hammer, and forms a passageway through the hammer 22. The interior surface 52 of mounting aperture 50 may be of any geometry that is compatible with the desired mounting pin and rotary shredding head with which the shredder hammer is intended to be used. Interior surface 52 may be shaped so that the mounting aperture 50 is approximately cylindrical. Alternatively, the interior surface 52 of mounting aperture 50 may define one or more curving surfaces, such as are described in U.S. Pat. No. 8,308,094 (hereby incorporated by reference).

The hammer 22 may be characterized in having a proximal or mounting portion 46 and a distal or working portion 48. The proximal portion 46 of hammer 22 may include a lifting eye 54. The lifting eye 54, when present, is typically disposed on the circumferential edge 42, for example where the longitudinal axis 44 intersects the circumferential edge. The lifting eye 54 may be used to facilitate the handling and movement of the shredder hammer 22, which may be both extremely heavy and relatively unwieldy.

The distal portion 48 of hammer body 34 is bounded by the distal portion of circumferential edge 42 including wear edge 56. In a preferred example, the wear edge 56 is defined as a convex arc along the distal edge of hammer 22. The shape of wear edge 56 as a convex arc helps prevent any undesired contact between the shredder hammer 22 and the walls of shredding chamber 16, particularly the anvil 24, as the shredder hammer rotates around mounting pin 32. The distal arc may be an arc of a circle that defines a radius. The center of curvature defining the arc is at or near the axis of rotation of the hammer and the center of pin 52. Alternatively, the wear edge is defined by one or more straight segments. In another alternative example the wear edge is defined by one or more straight segments combined with one or more curved segments.

The distal or working portion of hammer 22 may be differentiated from the proximal end of the hammer by a transverse axis 47 that passes through a reference point RP on the longitudinal axis between the wear edge and the center of gravity CG. The transverse axis may be a straight line 47A that passes through the reference point perpendicular to longitudinal axis 44. Alternatively, the transverse axis may be an arc 47B passing through the reference point. The arc is defined by an axis of curvature 47C along the longitudinal axis at or near the circumferential edge at the proximal end with a radius R1. Reference point RP on the longitudinal axis is spaced a distance d1 from the center of gravity and a distance d2 from the wear edge. Reference point RP in a preferred example is half way between the center of gravity and wear edge 56. Alternatively, the distance d1 may be one third the distance between the center of gravity and the wear edge along the longitudinal axis.

The transverse axis can define the separation of the distal portion 48 and the proximal portion 46 of hammer 22. The distal working portion of the hammer accomplishes most of the shredding and wears away during operation.

The wear edge 56 may be bounded on one or both sides by a segment of the circumferential edge, forming an impact face 58 for the shredder hammer 22. The shredder hammer may include at least one impact face 58, and the shredder hammer 22 may be mounted so that the impact face 58 faces the direction of rotation of the rotary shredding head 18. In another embodiment of the invention, the shredder hammer 10 includes two impact faces 58. The impact faces are a portion of the circumferential edge located at each end of the arc or wear edge 56. In this embodiment, the hammer is symmetric with respect to mirror plane 43, so that if a first impact face should become excessively worn, the shredder hammer may simply be rotated and remounted, presenting a second, unworn impact face to the direction of rotation; thereby extending the life of the shredder hammer 22 and rendering it more economical. In an alternative embodiment, the hammer is not symmetric with respect to plane 43.

At least one of the first and second major surfaces 36, 38 of hammer 22 may include a plurality of channels or recesses 60. The size and shape of each such recess 60 is defined by its walls 62, one of which can be considered the recess floor 64. That is, the particular conformations of the recess walls 62 determine the overall length 66 and depth 68 of a recess 60. Recess walls 62 refer to the side walls of a given recess, as well as a terminal or inner recess wall. The terminal recess wall or the floor 64 may not be present if the sidewalls of the recess taper toward each other and meet.

The recess walls include an upstream wall 60A and a downstream wall 60B defined by its orientation to an impact face 58 or the flow of material during operation. In some embodiments the upstream and downstream walls of a recess may have different configurations to take advantage of an associated impact face acting as the leading edge described further below. The upstream and downstream walls are opposed in that they are inclined to face each other or are parallel in extending from the recess floor 64. The upstream and downstream walls extending away from wear edge 56 may be parallel, may diverge or may converge.

In one embodiment of the invention, one or more recesses 60 are disposed on the distal portion 48 of the hammer 22, and extend from the wear edge 56 of the hammer into the interior of hammer 22. In another embodiment of the invention, the distal portion of the circumferential edge 42 includes a wear edge 56, and one or more of the plurality of recesses is oriented along a line normal to the curve of the wear edge 56 which is equivalent to the radius of the arc. Alternatively, one or more recesses or portions of recesses, may be oriented parallel to the longitudinal axis 44 of the hammer 22. Alternatively, one or more recesses may be formed in the major surfaces 36, 38 without extending to the wear edge 56. Alternatively, a hammer may have one or more recesses in accordance with any of the recesses described above.

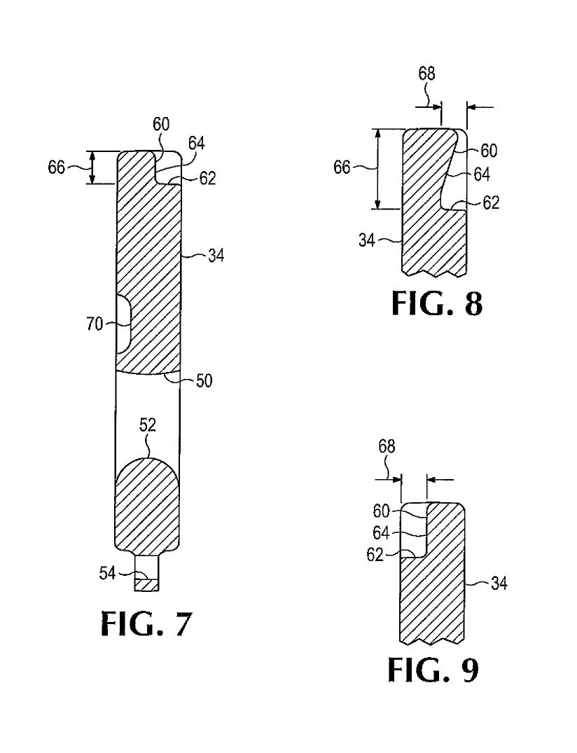

The particular size and shape of recesses 60 may vary on a single shredder hammer, as well as between different shredder hammers. Exemplary recesses 60 for shredder hammer 22 are shown in cross-section in FIGS. 7-9. As shown in FIG. 8, the recess depth 68 may vary across the extent of a particular recess 60. Where the recess depth varies over the length of the recess, the recess depth may increase as the recess extends toward the interior of the hammer from circumferential edge 42. Preferably recesses 60 have a maximum depth that does not exceed the midplane 45 to ensure sufficient hammer strength and reliability, but they could exceed the midpoint in certain circumstances.

The presence of one or more recesses 60 on the major surfaces of the hammer advantageously creates one or more auxiliary impact faces, which enhance the operational efficiency of the shredder hammer. During use, not only is material 14 impacted and crushed by a primary impact face 58 and between curved face 56 and anvil 24, the additional recesses 60 provide additional edges to engage the material, improving the ripping, tearing, impacting, and folding of the material between adjacent hammers and/or between the hammers and the anvil 24 or other chamber surface.

Recesses that extend to wear edge 56 typically cause wear edge 56 to become uneven as it wears. The recesses can reduce the exposed working area of edge 42. This area wears at a higher rate than surrounding portions that have a greater exposed working area. This creates a rippling effect to edge 56 as it wears. The rippling of the curved face as it wears creates another edge to contact the material for improved shredding and a more effective gripping surface that can dislodge material stuck in the mill grates 26 so it can be processed by subsequent hammer strikes.

In addition, and also advantageously, the recesses 60 formed in the major surfaces of the hammer extend the work hardening of the hammer. The recesses provide additional impact points on the side of the hammer and additional areas of hardening. This additional hardening results in a larger percentage of the volume of the hammer 22 becoming work hardened.

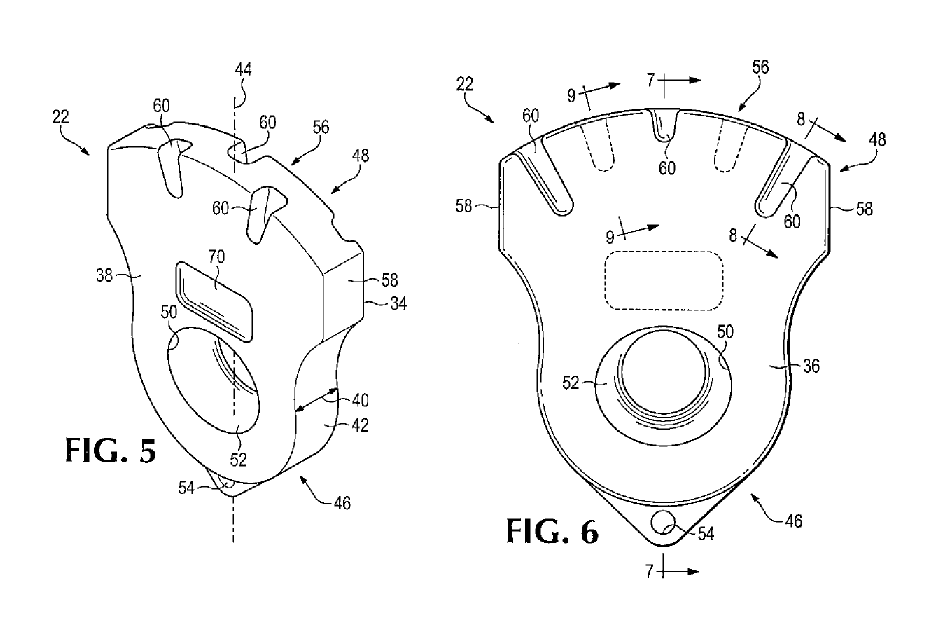

One or more of the major surfaces 36, 38 of the hammer 22 may include one or more concavities 70 in mounting portion 46 to reduce the volume of metal needed for the hammer in locations where the hammer does not wear. Concavity 70 is such a weight saving and cost saving recess proximate to aperture 50. Concavity 70 is remote from the primary metal impact zone (i.e. the working portion) of the hammer. Concavities 70 are predominantly within the mounting portion (though they could extend into the working portion) and are primarily for weight and cost reduction. Recesses 60 are predominantly within the working portion (though they could extend into the mounting portion) and are primarily for shredding the target material. Removal of metal at this location (i.e. in the mounting portion) does not limit the service life of the hammer. Moreover it can enhance the shredding by moving the center of gravity for the hammer closer to the wear edge 56. Such concavities may be of any suitable size and shape, provided that they are not of such size and/or depth that the recess compromises the structural integrity of the shredder hammer. As shown in FIGS. 5 and 7, concavity 70 of shredder hammer 22 has the outline of a rounded rectangle but it could have other shapes.

In one embodiment of the invention, recesses 60 are formed to have a sufficient recess length 66 and depth 68 so that the recesses will be maintained, and therefore confer their additional operational advantages, throughout the useable life of the hammer. For example, in one embodiment of the invention, each recess has a depth of from approximately one-tenth to approximately one-half of the thickness 40 of the hammer body. In alternative embodiments, one or more recesses in the hammer may extend beyond the center cross section of the hammer.

As exemplified by the shredder hammer of FIGS. 4-9, the shredder hammer 22 may include a plurality of recesses 60 on both the first and second major surfaces 36, 38 of hammer 22. Where there are recesses on both faces of the hammer, the recesses may be disposed symmetrically or asymmetrically. Furthermore, the recesses may be disposed symmetrically with respect to the plane of symmetry 43, or disposed asymmetrically with respect to mirror plane 43. In one embodiment of the invention, the shredder hammer has recesses on both major surfaces, and the recesses do not superpose. For example, as shown in FIG. 6, the recesses 60 of shredder hammer 22 are disposed symmetrically with respect to mirror plane 43, but are asymmetrical and nonsuperposable with respect to the midplane 45 of the hammer 22.

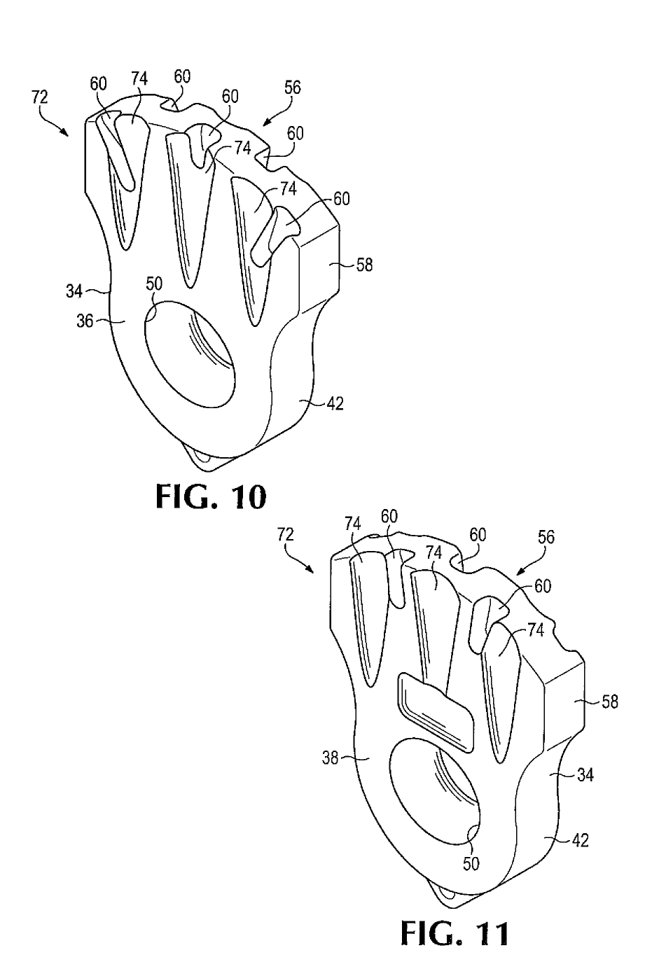

FIGS. 10-11 depict an alternative embodiment of a shredder hammer according to the present invention. Similar to shredder hammer 22, shredder hammer 72 includes a plate-like hammer body 34, a first major surface 36 and second major surface 38, and a circumferential edge 42. Also similarly, the distal portion of circumferential edge 42 defines a wear edge 56 that is modified by a plurality of recesses 60. However, shredder hammer 72 additionally includes alternative fluted recesses 74 on major surfaces 36 and 38. That is, a plurality of shallow fluted recesses 74 is superimposed upon the recesses 60. Similarly to the recited advantages of forming recesses on the presently disclosed shredder hammers, the addition of the recesses 74 to shredder hammer 72 creates additional features to enhance gripping and tearing of the material to be shredded, as well as permitting work hardening to extend into the hammer body.

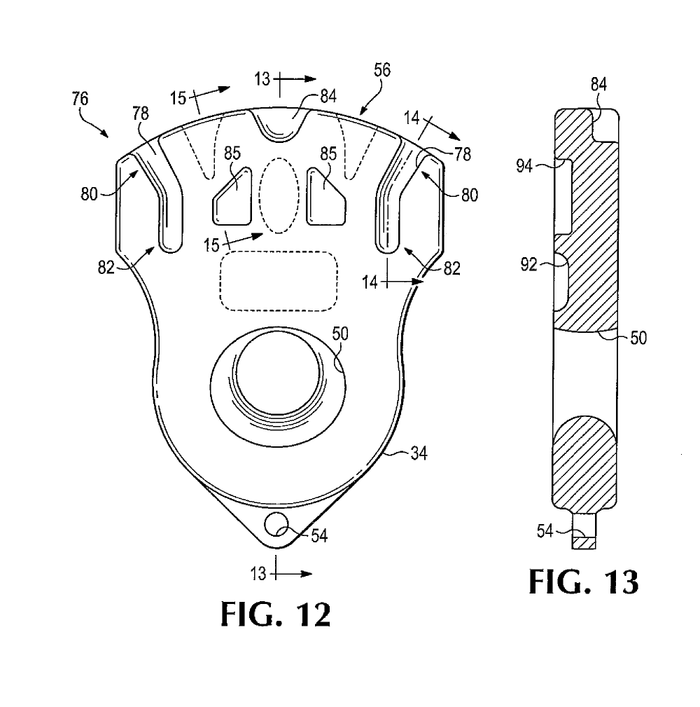

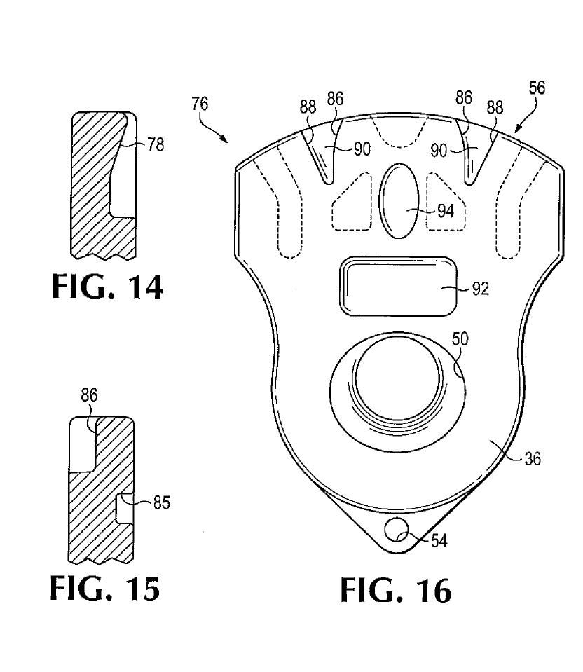

FIGS. 12-16 depict another alternative embodiment of a shredder hammer according to the present invention. Shredder hammer 76 is similar to previously discussed shredder hammers, but differs in the particular arrangement of recesses formed in the hammer 22. As shown in FIGS. 12-16, the first major surface 36 of shredder hammer 76 includes recesses 78 that have a distal portion 80 that extends along a line normal to wear edge 56, and a proximal portion 82 that is oriented parallel to a longitudinal axis of the hammer 22. Recess 78 is further configured to increase in depth as the recess extends from the circumferential edge into the hammer body. Shredder hammer 76 also includes a relatively short and broad recess 84 disposed at the center point of the wear edge 56. First major surface 36 further includes two symmetrically disposed recesses 85, which have trapezoidal outlines, but could be any shape including triangular or square.

Major surface 38 of hammer 76 in FIG. 16 includes recesses 86 predominantly in the working portion, which are defined by a first recess wall 88 that extends along a line normal to wear edge 56, and a second arcuate and convex recess wall 90 that, in combination with recess wall 88, forms recess 86. The second major surface of shredder hammer 76 includes two surface features: a concavity 92 predominately in the mounting portion having a rounded rectangular outline, and a recess 94 predominately in the working portion having an oval outline.

Concavity 92 like concavity 70 is predominately in the mounting portion 46 of the hammer, which reduces the overall weight of the hammer without substantial reduction in operational effectiveness. During operation as the hammer spins at high speed, mass at the distal end travels at a much higher velocity with greater momentum than mass in the mounting portion. The reduction in mass at mounting end 46 has limited effect on the impact provided by the hammer and reduces the mass that is scrapped at the end of the service life of the hammer.

At the corners formed by the distal edge, the hammer face and a recess wall, the hammer material is not as well supported by surrounding material and is exposed to the full impact against target materials. These corners can tend to break away particularly on initial operation of the hammer when the material has not work hardened. The configuration of recess 78 where the recess is shallower at the edge 42, and increases in depth moving away from the edge, provides better support and limits cracking at the wall of the recess and proximate to the circumferential edge 42. As the hammer wears away exposing the deeper part of recess 78, the hammer material has hardened and is less vulnerable to cracking at the recess walls. The hammer also has less mass and therefore less impact energy during use.

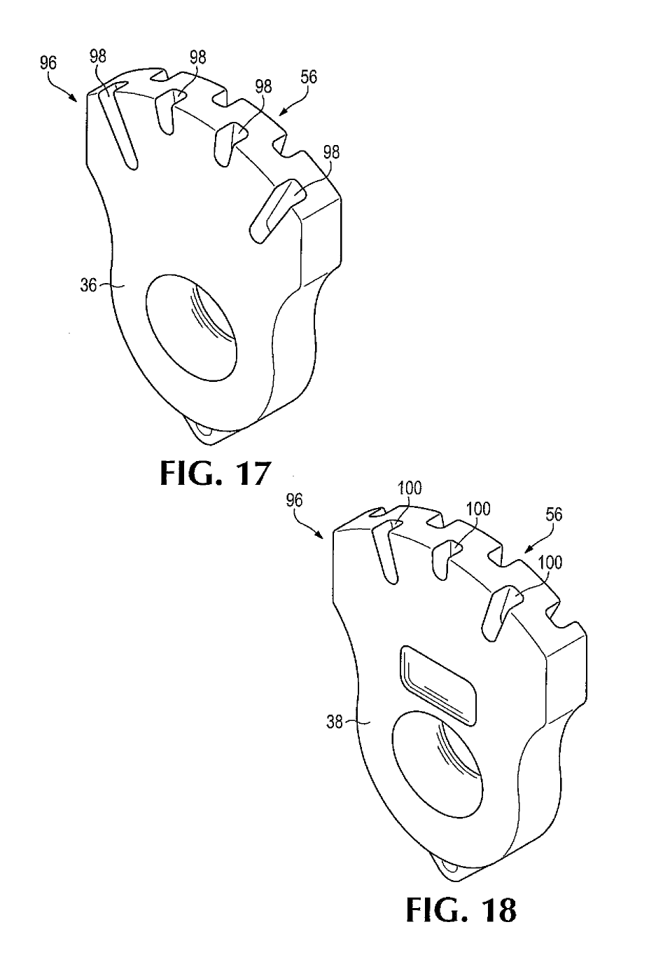

FIGS. 17-18 depict another alternative embodiment of a shredder hammer according to the present invention. Shredder hammer 94 is similar to previously discussed shredder hammer 22, but differs in the particular arrangement of recesses formed in the hammer. As shown in FIGS. 17-18, the first major surface 36 of shredder hammer 96 includes four recesses 98 that each extend along a line normal to wear edge 56. The second major surface 38 of shredder hammer 94 includes three recesses 100 that also extend along lines normal to wear edge 56. Although recesses 98 and recesses 100 are each symmetrically disposed, they are non-superposable with each other.

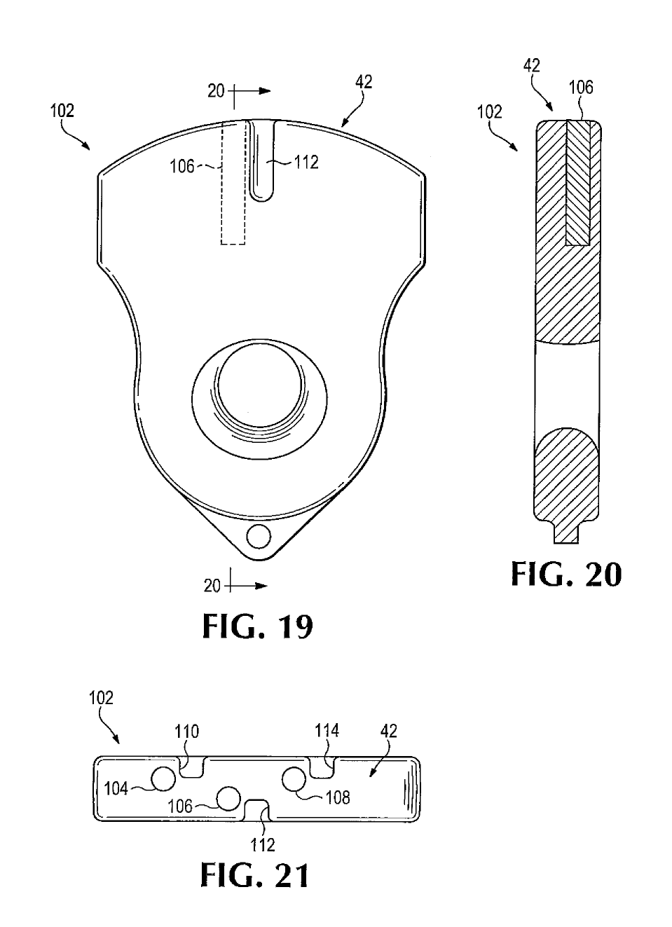

FIGS. 19-21 depict another alternative embodiment of a shredder hammer according to the present invention. Hammer 102 is similar to previously discussed hammer 22. Here the hammer includes inserts 104, 106 and 108 of a different material than the hammer body. The insert may comprise a hardened material such as diamond, tungsten carbide or carbon nitride. The inserts shown are located proximate to recesses 110, 112 and 114 preferably adjacent the downstream edge.

The inserts may be inserted into cast or drilled holes in the edge of hammer 102 and secured in place by gluing or soldering or any other similar method that retains the inserts. In an alternate aspect, inserts may be cast in place when the hammer is manufactured. In another alternative aspect, the hammer could be cast with recesses open at least on a side of the hammer and configured to accept an insert. The inserts could be positioned in the side of the hammer and the insert then secured in place again by gluing, soldering or some other method.

The inserts provide an additional engagement point together with the recesses to engage the consolidated material and exert shearing forces to separate it into smaller portions.

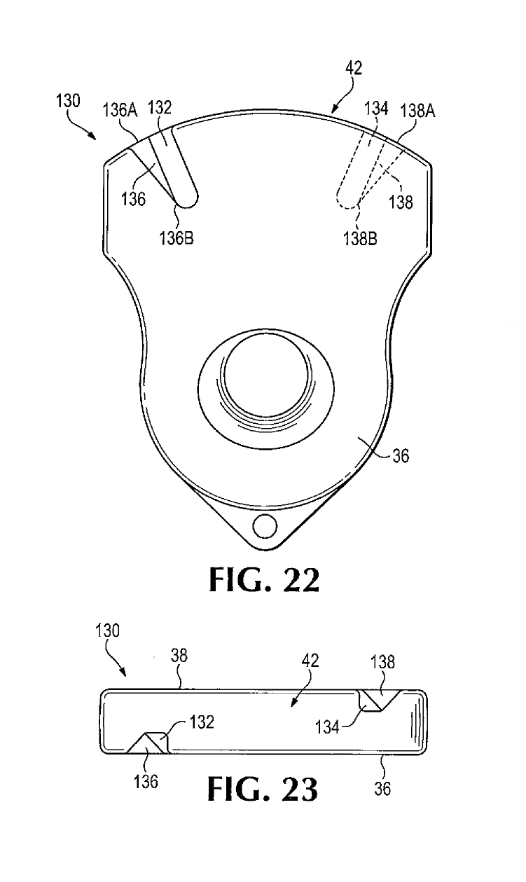

FIGS. 22-23 depict yet another alternative embodiment of a shredder hammer according to the present invention. Shredder hammer 130 is similar to previously discussed shredder hammers, but differs in the particular arrangement of recesses formed in the hammer body.

The shredder hammer 130 includes one recess 134 opening to surface 36 and edge 42 and one recess 132 opening to opposite surface 38 and edge 42. Recess 132 includes a recess transition configured as a bevel portion 136. Recess 134 includes a recess transition configured as a bevel portion 138. These bevels are typically formed on the upstream side of the recess and permit better material access in the recess for improved shredding. The bevel provides a less pronounced approach to the recess than a right angle transition from the surface into the recess.

The transition portion can be any configuration that provides a less abrupt and more extended transition from the hammer surface to the recess. Here the bevel portion is a planar surface that extends from the bottom of the recess to the hammer surface along line 136A at the edge 42 at an obtuse angle to the surface. Extending away from edge 42 the edges of the bevel converge to a point 136B on the hammer surface so the bevel plane forms a triangular shape. Again, the recess transition could be another configuration such as a rounded edge or a bevel that does not extend to the bottom of the recess. At least a portion of the recess transition will form an obtuse angle to the surface of the hammer that opens up the recess at the upstream edge, and with metals that flow is less subject to formation of a cornice.

Some hammer materials exhibit a tendency to flow under specific circumstances. A sharp edge of a recess where it transitions from a hammer face to a recess wall has been shown in embodiments without a transition surface 136 and 138 as a right angle. Under repeated impacts the material of the hammer face can deform and deflect to create an overhang extending partially or entirely over the recess that limits the size of or closes the recess opening. This can reduce the amount of material impacted by the downstream edge of the recess. Modifying the leading or upstream edge of the recess from a right angle to a more extended transition reduces the tendency to form these features.

In addition to the advantages of the presently disclosed shredder hammers with respect to increased functional efficiency, the shredder hammers of the present invention may also offer advantages with respect to their manufacture. Although the recesses of the shredder hammers of the present invention may be machined into a shredder hammer body after casting, these features are preferably incorporated into the casting mold used to fabricate the shredder hammer from molten metal. The presence of recesses increase hammer surface area, which in turn increases cooling effects during casting resulting in better metal grain structure and depth of hardness, particularly for large hammers (e.g., those of 4 inches of thickness or more). The recited features of the disclosed shredder hammers are designed to improve freeze-off, solidification, and quenching during the casting process and heat treatment to improve material properties and product reliability. The use of casting molds incorporating these features result in improved material properties during the casting process, in turn resulting in greater wear performance and reliability for the resulting shredder hammers.

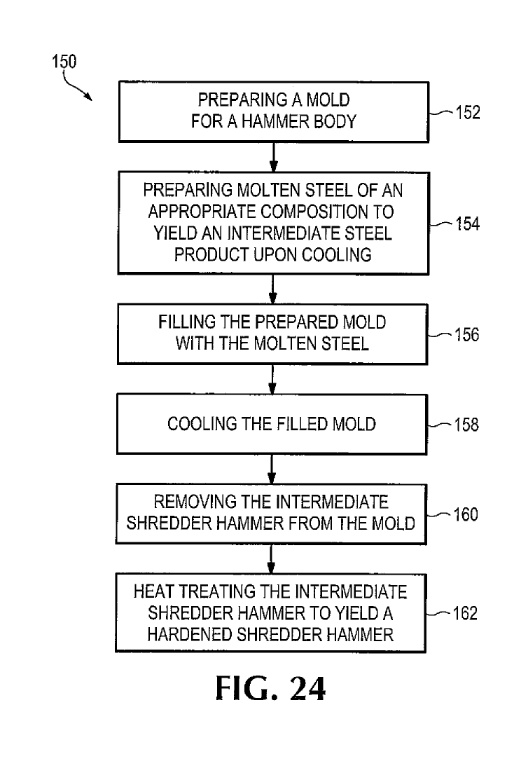

The presently disclosed shredder hammers may be manufactured using standard steel casting processes, as reflected by flowchart 150 of FIG. 24. These processes may include preparing a mold for the hammer body, at 152 including features or inserts corresponding to recesses adjacent a circumferential edge of the mold and extending from a face without extending past a midplane of the mold; preparing molten steel of an appropriate composition to yield an intermediate steel product having the desired initial mechanical properties upon cooling, at 154; filling the prepared mold with the molten steel, at 156; cooling the filled mold at 158; removing the intermediate shredder hammer from the mold, at 160; and heat treating the intermediate shredder hammer to adjust the mechanical properties to yield the desired hardened shredder hammer, at 162.

In some cases it may be advantageous to manufacture the hammer so that the shredding recesses (i.e., those predominately in the working portion) are proximate or adjacent to edge 42 but do not open to the edge. The hammer may be manufactured with a thin wall or partition between the edge 42 and the recesses so the recess is spaced from wear edge 56. When installed and initially operated, this partition is either worn away or quickly separates from the hammer providing the advantages of a recess on initial operation and through the service life of the hammer. All of the advantages of the recesses are realized in operation though the recesses are not initially open at edge 42. Alternatively, the shredding recesses can be completely open (i.e. through the entire thickness) for a span (such as along wear edge 56) so long as most of the recess extends only part way through the thickness of the hammer for sufficient strength and reliability.

It should be appreciated that although selected embodiments of the representative shredder hammers are disclosed herein, numerous variations of these embodiments are possible. This presently disclosed shredder hammer design lends itself to use for manganese, steel alloy and composite hammer types, and the resulting hammers are well suited to a variety of shredding applications beyond metal shredding and metal recycling.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

1. A shredder hammer comprising:
a pair of major surfaces;
a circumferential edge connecting the major surfaces including a wear edge;
a hole extending through the hammer and opening in each of the major surfaces to receive a support pin for mounting the shredder hammer in a shredding machine; and
a working portion of the hammer remote from the hole including:
the wear edge; and
at least one recess open to a major surface with opposing walls that extend away from the wear edge.

2. The shredder hammer of claim 1 where at least a portion of the wear edge is an arc defined by a center of curvature in the hole.

3. The shredder hammer of claim 2 where at least one of the recesses extends along a line between the arc and the center of curvature.

4. The shredder hammer of claim 1 where the recess extends from the wear edge towards a mounting end that includes the hole and varies in depth as it extends.

5. The shredder hammer of claim 1 where the recess increases in depth extending from the wear edge.

6. The shredder hammer of claim 1 where the circumferential edge includes an impact face adjacent the wear edge, and one of the opposing walls is on a downstream side away from the impact face substantially perpendicular to the respective major surface and another of the opposing walls is on an upstream side toward the impact face and at least a portion of the opposing wall on the upstream side is at an obtuse angle to the respective surface where the recess opens to the major surface.

7. The shredder hammer of claim 6 where the opposing wall on the upstream side includes a beveled plane that diverges from the major surface towards a bottom of the recess.

8. The shredder hammer of claim 1 where the at least one recess includes first and second recess ends and the opposed walls define a width at their widest separation, and the first end of the recess is separated from the wear edge by no more than the width between the walls and the second end extends away from the wear edge.

9. The shredder hammer of claim 1 where the at least one recess opens to the wear edge.

10. The shredder hammer of claim 1 which includes a longitudinal axis and at least one recess extends parallel to the longitudinal axis.

11. The shredder hammer of claim 1 where the spacing between the major surfaces defines a thickness and the recess has a depth that is between one tenth and one half the thickness.

12. The shredder hammer of claim 1 which includes a center of gravity and a longitudinal axis extending through the center of the hole, the center of gravity and a reference point between the center of gravity and the wear edge, the reference point spaced from the center of gravity at least one third the distance between the center of gravity and the wear edge, and the working portion is defined by a line extending across the hammer through the reference point and perpendicular to the longitudinal axis, the line separating the working portion of the hammer from a mounting portion of the hammer that includes the hole.

13. The shredder hammer of claim 1 which includes a center of gravity and a longitudinal axis extending through the center of the hole, the center of gravity and a reference point between the center of gravity and the wear edge, the reference point spaced from the center of gravity at least one third the distance between the center of gravity and the wear edge, and the working portion is defined by an arc extending across the hammer through the reference point, the arc with a center of curvature at the intersection of the longitudinal axis and the circumferential edge in the mounting portion, the arc separating the working portion of the hammer from a mounting portion of the hammer that includes the hole.

14. The shredder hammer of claim 1 which includes at least one recess in each major surface.

15. The shredder hammer of claim 1 where the at least one recess is predominantly in the working portion.

16. The shredder hammer of claim 15 which includes at least one concavity predominantly in the mounting portion.

17. The shredder hammer of claim 1 which includes a plurality of recesses in the working portion.

18. The shredder hammer of claim 1 where at least most of the recess extends only partially through the hammer thickness.

19. The shredder hammer of claim 1 where the recess extends partially through the thickness of the hammer.

20. A shredder system including:
a shredding chamber that encloses a rotary shredding head with a plurality of shredder hammers pivotally mounted by a support pin to the rotary shredding head, each shredder hammer with:
a pair of major surfaces;
a circumferential edge connecting the major surfaces including a wear edge;
a hole extending through the hammer and opening in each of the major surfaces to receive the support pin; and
a working portion of the hammer remote from the hole including:
the wear edge; and
at least one recess open to a major surface with opposing walls that extend away from the wear edge.

21. The shredder system of claim 20 where the hammer is free to rotate about the support pin.

22. The shredder system of claim 20 where the recess increases in depth extending from the wear edge.

23. The shredder system of claim 20 where the spacing between the major surfaces defines a thickness and the recess has a depth that is between one tenth and one half the thickness.

24. The shredder system of claim 20 where the circumferential edge includes an impact face adjacent the wear edge, and one of the opposing walls is on a downstream side away from the impact face substantially perpendicular to the respective major surface and another of the opposing walls is on an upstream side toward the impact face and at least a portion of the opposing wall on the upstream side is at an obtuse angle to the respective surface where the recess opens to the major surface.

25. The shredder system of claim 20 which includes a center of gravity and a longitudinal axis extending through the center of the hole, the center of gravity and a reference point between the center of gravity and the wear edge, the reference point spaced from the center of gravity at least one third the distance between the center of gravity and the wear edge, and the working portion is defined by a line extending across the hammer through the reference point and perpendicular to the longitudinal axis, the line separating the working portion of the hammer from a mounting portion of the hammer that includes the hole.

26. The shredder system of claim 20 which includes a center of gravity and a longitudinal axis extending through the center of the hole, the center of gravity and a reference point between the center of gravity and the wear edge, the reference point spaced from the center of gravity at least one third the distance between the center of gravity and the wear edge, and the working portion is defined by an arc extending across the hammer through the reference point, the arc with a center of curvature at the intersection of the longitudinal axis and the circumferential edge in the mounting portion, the arc separating the working portion of the hammer from a mounting portion of the hammer that includes the hole.
